(19) United States
(12) Patent Application Publication
(10) Pub. No.: US 2021/0126806 A1
(43) Pub. Date: Apr. 29, 2021

(54) METHOD FOR RECOGNIZING AND UTILIZING USER FACE BASED ON PROFILE PICTURE IN CHATROOM CREATED USING GROUP ALBUM

(71) Applicant: LINE Plus Corporation, Seongnam-si (KR)

(72) Inventors: Hyukjae JANG, Seongnam-si (KR); Ji Hyeon PARK, Seongnam-si (KR); Hyeyoung KWON, Seongnam-si (KR)

(73) Assignee: LINE Plus Corporation, Seongnam-si (KR)

(21) Appl. No.: 17/081,031

(22) Filed: Oct. 27, 2020

(30) Foreign Application Priority Data
Oct. 28, 2019 (KR) 10-2019-0134462

(51) Int. Cl. H04L 12/18; H04L 12/58; G06K 9/00

(52) U.S. Cl. CPC H04L 12/1818; G06K 9/00288; H04L 51/10; H04L 51/04

(57) ABSTRACT

Provided is a method of recognizing and utilizing a user face based on a profile picture in a group chatroom created using a group album. A user face recognition method performed by a computer system may include recognizing at least one object from an image shared in an instant messaging service; and identifying a user account of the instant messaging service associated with the recognized at least one object.

### CROSS-REFERENCE TO RELATED APPLICATION

This application claims priority to Korean Patent Application No. 10-2019-0134462, filed Oct. 28, 2019 in the Korean Intellectual Property Office, the disclosure of which is incorporated herein by reference in its entirety.

### BACKGROUND

### 1. Field

Apparatuses, systems, and methods according to example embodiments relate to technology for recognizing a user face based on an image.

### 2. Description of Related Art

An instant messenger refers to software that may transmit and receive messages or data in real time. Through the instant messenger, a user may register a contact and may transmit and receive messages with a counterpart included in a contact list in real time. Due to such a messenger function, the use of the messenger is common not only in a personal computer (PC) environment but also in a mobile environment of a mobile communication terminal.

As the use of the instant messenger becomes popular and functions provided from the instant messenger become increasingly diverse, a conversation with a counterpart may be performed with more than one counterpart user. For example, a user may create a group chatroom and invite a counterpart to the created group chatroom. In this manner, the user and the counterpart may conduct a conversation through message transmission and reception and may share a variety of contents, such as, for example, pictures, videos, and documents.

In the instant messenger, a picture of another person, a pet or a background picture may be registered as a profile picture to each user account instead of a picture of a corresponding user. Therefore, a face of a user may not be accurately identified only with a profile picture registered to a user account. Also, because a picture being shared in a group chatroom of the instant messenger is stored in a server for a relatively short period of time set in a messenger service, the picture may not be verified later.

### SUMMARY

One or more embodiments provide a method and system that may recognize a face of a user from an image by analyzing the context on contents of the conversation of messages transmitted and received using an instant messaging service.

One or more embodiments provide a method and system that may recognize a face from an image shared in an instant messaging service, may invite a user account associated with the recognized face, or may create a new group chatroom.

According to an aspect of an example embodiment, a user face recognition method is performed by a computer system and includes: recognizing at least one object from an image shared in an instant messaging service; and identifying a user account of the instant messaging service associated with the recognized at least one object.

The may further include inviting the identified user account of the instant messaging service to be a member of a group chatroom provided by the instant messaging service.

The may further include creating a new group chatroom that includes the identified user account of the instant messaging service.

The may further include: determining whether the identified user account of the instant messaging service is a current member of a group chatroom provided by the instant messaging service; and inviting the user account that is not the current member of the group chatroom to be a new member of the group chatroom.

The method may further include: identifying a face of a user that is a member of a chatroom from a picture shared in another group chatroom in which the user does not participate as a member; and providing a friend recommendation interface to the user indicating members included in the other group chatroom in which the picture is shared.

The method may further include: receiving an indication of a picture selected from a group album; identifying at least one group chatroom of the instant messaging service that includes members corresponding to persons present in the picture; and transmitting the selected picture to the at least one group chatroom.

The method may further include: classifying, with respect to pictures shared in a group chatroom of the instant messaging service or in a group album configured in the group chatroom, pictures of members included in the group chatroom; and providing the classified pictures of the members.

The method may further include: classifying a picture of a friend registered to the instant messaging service among pictures uploaded to all group chatrooms present in the instant messaging service or a group album configured in one of the group chatrooms; and providing the classified picture of the friend.

The method may further include providing a timeline view on a profile of a user provided at the instant messaging service that includes pictures of the user shared in the instant messaging service.

The recognizing may include analyzing context of a conversation through messages transmitted and received in a group chatroom of the instant messaging service and recognizing a face of a user from the shared image based on the analyzed context, and the user may be recognized as the at least one object.

The method may further include registering user information to the instant messaging service based on an image captured through an in-app camera provided at the instant messaging service, and the recognizing may include recognizing a face of a user from the shared image based on the user information registered to the instant messaging service using the image captured through the in-app camera.

The recognizing may include recognizing a face of a user from the shared image based on profile pictures of members present in a group chatroom of the instant messaging service.

The recognizing may include recognizing a face of a user from the shared image based on picture information within a group album present in a group chatroom of the instant messaging service.

The recognizing may include analyzing context of a conversation through messages transmitted and received in a group chatroom of the instant messaging service and recognizing a face of a user from the shared image by clustering through comparison between candidate sets for recognizing the face of the user, and the user may be recognized as the at least one object.

The recognizing may include generating identification information of a user estimated based on messages transmitted and received using the instant messaging service, and the at least one object may be recognized from the shared image based on the generated identification information.

The method may further include generating the identification information of the user by analyzing a conversation style of a conversation transmitted and received through messages input using the instant messaging service and a user account registered to the instant messaging service.

According to an aspect of an example embodiment, a non-transitory computer-readable record medium stores instructions that, when executed by a processor, cause the processor to perform a user face recognition method that includes: recognizing at least one object from an image shared in an instant messaging service; and identifying a user account of the instant messaging service associated with the recognized at least one object.

According to an aspect of an example embodiment, a computer system for performing a user face recognition includes: at least one memory configured to store computer-readable instructions; and at least one processor configured to execute the computer-readable instructions to implement: an object recognizer configured to recognize at least one object from an image shared in an instant messaging service; and a friend recommender configured to identify a user account of the instant messaging service associated with the recognized at least one object.

The friend recommender may be further configured to invite the identified user account of the instant messaging service to be a member of a group chatroom provided by the instant messaging service, or to create a new group chatroom that includes the identified user account of the instant messaging service.

The object recognizer may be further configured to analyze context of messages transmitted and received in a group chatroom of the instant messaging service and to recognize a face of a user from the shared image through the analyzed context as the at least one object.

### BRIEF DESCRIPTION OF THE FIGURES

The above and/or other aspects will be more apparent by describing certain example embodiments, with reference to the accompanying drawings, in which:

FIG. 1 is a diagram illustrating an example of a network environment according to at least one example embodiment;

FIG. 2 is a diagram illustrating an example of a configuration of an electronic device and a server according to at least one example embodiment;

FIG. 3 is a diagram illustrating an example of components includable in a processor of a server according to at least one example embodiment;

FIG. 4 is a flowchart illustrating an example of a facial recognition method performed by a server according to at least one example embodiment;

FIG. 5 illustrates an example of creating a group chatroom according to at least one example embodiment;

FIG. 6 illustrates an example of selecting an image according to at least one example embodiment;

FIG. 7 illustrates an example of recognizing an object from an image according to at least one example embodiment;

FIG. 8 illustrates an example of inviting a member to a group chatroom according to at least one example embodiment; and

FIG. 9 illustrates an example of sharing an image according to at least one example embodiment.

### DETAILED DESCRIPTION

Example embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the example embodiments. However, it is apparent that the example embodiments can be practiced without those specifically defined matters. Also, well-known functions or constructions are not described in detail since they would obscure the description with unnecessary detail.

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware and/or a combination of hardware and software. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor), Central Processing Unit (CPU), a controller, an arithmetic logic unit (ALU), a digital signal processor, a microcomputer, a microprocessor, etc., the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer record medium or device, capable of providing instructions or data to, or being interpreted by, a hardware device. The software also may be distributed over network coupled computer systems so that the software is stored and executed in a distributed fashion. In particular, for example, software and data may be stored by one or more computer readable record mediums, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive, solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable record medium into the one or more storage devices and/or one or more computer processing devices using a drive mechanism. Such separate computer readable record medium may include a Universal Serial Bus (USB) flash drive, a memory stick, a Blue-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable record medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, example embodiments will be described with reference to the accompanying drawings.

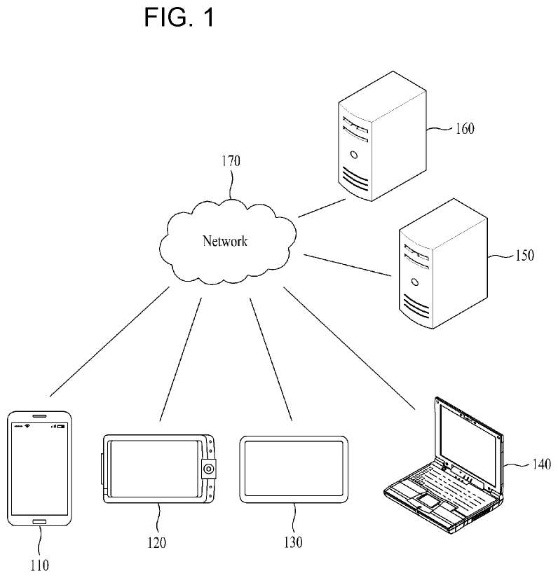

FIG. 1 illustrates an example of a network environment according to at least one example embodiment. Referring to FIG. 1, the network environment may include a plurality of electronic devices 110, 120, 130, and 140, a plurality of servers 150 and 160, and a network 170. FIG. 1 is provided as an example only. A number of electronic devices or a number of servers is not limited thereto.

Each of the plurality of electronic devices 110, 120, 130, and 140 may be a stationary terminal or a mobile terminal that is configured as a computer system. For example, the plurality of electronic devices 110, 120, 130, and 140 may be a smartphone, a mobile phone, a navigation device, a computer, a laptop computer, a digital broadcasting terminal, a personal digital assistant (PDA), a portable multimedia player (PMP), a tablet PC, a game console, a wearable device, an Internet of things (IoT) device, a virtual reality (VR) device, an augmented reality (AR) device, and the like. For example, although FIG. 1 illustrates a shape of a smartphone as an example of the electronic device 110, the electronic device 110 used herein may refer to one of various types of physical computer systems capable of communicating with other electronic devices 120, 130, and 140, and/or the servers 150 and 160 over the network 170 in a wireless or wired communication manner.

The communication scheme is not limited and may include a near field wireless communication scheme between devices as well as a communication scheme using a communication network (e.g., a mobile communication network, wired Internet, wireless Internet, a broadcasting network, a satellite network, etc.) includable in the network 170. For example, the network 170 may include at least one of network topologies that include a personal area network (PAN), a local area network (LAN), a campus area network (CAN), a metropolitan area network (MAN), a wide area network (WAN), a broadband network (BBN), Internet, and the like. Also, the network 170 may include at least one of network topologies that include a bus network, a star network, a ring network, a mesh network, a star-bus network, a tree or hierarchical network, and the like. However, they are provided as examples only.

Each of the servers 150 and 160 may be configured as a computer apparatus or a plurality of computer apparatuses that provides an instruction, a code, a file, content, a service, etc., through communication with the plurality of electronic devices 110, 120, 130, and 140 over the network 170. For example, the server 150 may be a system that provides a first service to the plurality of electronic devices 110, 120, 130, and 140 connected over the network 170. The server 160 may be a system that provides a second service to the plurality of electronic devices 110, 120, 130, and 140 connected over the network 170. In detail, the server 150 may provide a service (e.g., a messaging service, etc.) intended by an application through the application as a computer program installed and executed on the plurality of electronic devices 110, 120, 130, and 140, as the first service. As another example, the server 160 may provide the plurality of electronic devices 110, 120, 130, and 140 with a service that distributes a file for installing and executing the application, as the second service.

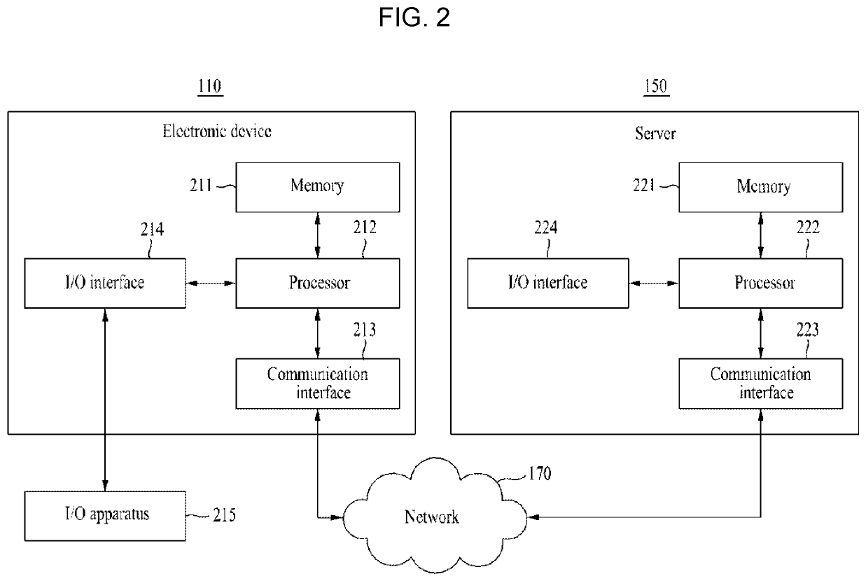

FIG. 2 is a block diagram illustrating an example of an electronic device and a server according to example embodiments. Description is made using the electronic device 110 as an example of the electronic device and the server 150 as an example of the server with reference to FIG. 2. Also, the other electronic devices 120, 130, and 140 or the server 160 may have the same or similar configuration as that of the electronic device 110 or the server 150.

Referring to FIG. 2, the electronic device 110 may include a memory 211, a processor 212, a communication interface 213, and an input/output (I/O) interface 214, and the server 150 may include a memory 221, a processor 222, a communication interface 223, and an I/O interface 224. The memory 211, 221 may include a permanent mass storage device, such as random access memory (RAM), read only memory (ROM), a disk drive, a solid state drive (SSD), a flash memory, etc., as a non-transitory computer-readable record medium. The permanent mass storage device, such as ROM, SSD, flash memory, and disk drive, may be included in the electronic device 110 or the server 150 as a permanent storage device separate from the memory 211, 221. Also, an OS or at least one program code (e.g., a code for a browser installed and executed on the electronic device 110 or an application installed and executed on the electronic device 110 to provide a specific service) may be stored in the memory 211, 221. Such software components may be loaded from another non-transitory computer-readable record medium separate from the memory 211, 221. The other non-transitory computer-readable record medium may include a non-transitory computer-readable record medium, for example, a floppy drive, a disk, a tape, a DVD/CD-ROM drive, a memory card, etc. According to other example embodiments, software components may be loaded to the memory 211, 221 through the communication interface 213, 223, instead of the non-transitory computer-readable record medium. For example, at least one program may be loaded to the memory 211, 221 based on a computer program, for example, the application, installed by files provided over the network 170 from developers or a file distribution system, for example, the server 160, providing an installation file of the application.

The processor 212, 222 may be configured to process instructions of a computer program by performing basic arithmetic operations, logic operations, and I/O operations. The computer-readable instructions may be provided from the memory 211, 221 or the communication interface 213, 223 to the processor 212, 222. For example, the processor 212, 222 may be configured to execute received instructions in response to the program code stored in the storage device, such as the memory 211, 221.

The communication interface 213, 223 may provide a function for communication between the electronic device 110 and the server 150 over the network 170 and may provide a function for communication between the electronic device 110 and another electronic device, for example, the electronic device 120, or another server, for example, the server 160, and/or between the server 150 and another electronic device or server. For example, the processor 212 of the electronic device 110 may transfer a request created based on a program code stored in the storage device such as the memory 211, to the server 150 over the network 170 under control of the communication interface 213. The electronic device 110 may receive a control signal, an instruction, content, a file, etc., provided under control of the processor 222 of the server 150 through the communication interface 213 of the electronic device 110, from the communication interface 223 of the server 150. For example, a control signal, an instruction, content, a file, etc., of the server 150 received through the communication interface 213 may be transferred to the processor 212 or the memory 211, and content, a file, etc., may be stored in a storage medium, for example, the permanent storage device, further includable in the electronic device 110.

The I/O interface 214 may be a device used for interface with an I/O apparatus 215. For example, an input device may include a device, such as a keyboard, a mouse, a microphone, a camera, etc., and an output device may include a device, such as a display, a speaker, a haptic feedback device, etc. As another example, the I/O interface 214 may be a device for interface with an apparatus in which an input function and an output function are integrated into a single function, such as a touchscreen. The I/O apparatus 215 may be configured as a single device with the electronic device 110. Also, the I/O interface 224 of the server 150 may be a device for interface with an apparatus for input or output that may be connected to the server 150 or included in the server 150. In detail, when the processor 212 of the electronic device 110 processes an instruction of a computer program loaded to the memory 221, content or a service screen configured based on data provided from the server 150 or the electronic device 120 may be displayed on the display through the I/O interface 214.

According to other example embodiments, the electronic device 110 and the server 150 may include a number of components less than or greater than a number of components shown in FIG. 2. For example, the electronic device 110 may include at least a portion of the I/O apparatus 215, or may further include other components, for example, a transceiver, a global positioning system (GPS) module, a camera, a variety of sensors, a database (DB), and the like. In detail, if the electronic device 110 is a smartphone, the electronic device 110 may be configured to further include a variety of components, for example, an accelerometer sensor, a gyro sensor, a camera module, various physical buttons, a button using a touch panel, an I/O port, a vibrator for vibration, etc., which are generally included in the smartphone.

A computer-implemented facial recognition system may be provided by the server 150 according to an example embodiment. For example, the server 150 may be a system that provides an instant messaging service to the electronic device 110, for example, a user terminal. The facial recognition system may provide a function of recommending a counterpart user corresponding to a face recognized in response to performing a facial recognition at the instant messaging service. Therefore, a user may invite a user account associated with a face recognized from the image shared in the instant messaging service to a group chatroom or may allow the user account to join a conversation with the subject of a specific event in response to creation of a new group chatroom.

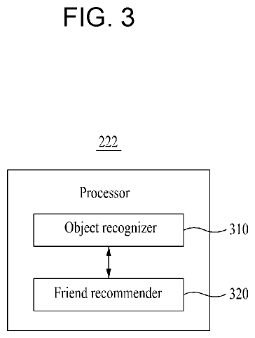

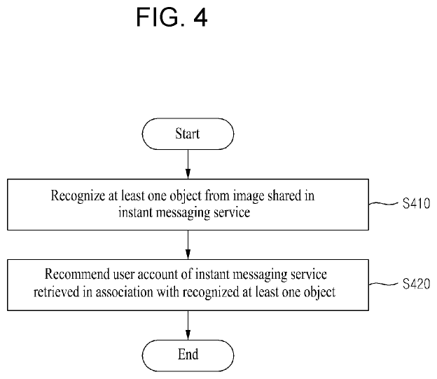

FIG. 3 is a diagram illustrating an example of components includable in a processor of a server according to at least one example embodiment, and FIG. 4 is a flowchart illustrating an example of a facial recognition method performed by a server according to at least one example embodiment.

Referring to FIG. 3, the processor 222 of the server 150 may include an object recognizer 310 and a friend recommender 320. The components of the processor 222 may be representations of different functions performed by the processor 222 in response to a control instruction provided from a program code stored in the server 150. The processor 222 and the components of the processor 222 may control the server 150 to perform operations S410 and S420 included in the facial recognition method of FIG. 4. Here, the processor 222 and the components of the processor 222 may be configured to execute an instruction according to a code of at least one program and a code of an OS included in the memory 221.

The processor 222 may load, to the memory 221, a program code stored in a file of a program for the facial recognition method. For example, in response to the program being executed at the server 150, the processor 222 may control the server 150 to load, to the memory 221, a program code from the file of the program under control of the OS. Here, the processor 222 and the object recognizer 310 and the friend recommender 320 included in the processor 222 may be different functional representations of the processor 222 executing an instruction of a corresponding portion in the program code loaded to the memory 221 to perform operations S410 and S420.

Referring to FIG. 4, in operation S410, the object recognizer 310 may recognize at least one object from an image shared in an instant messaging service. For example, the object recognizer 310 may recognize an object from an image that includes a picture, a video, and the like. Here, the object may refer to a thing and a person, as well as specific information of the thing and the person. Hereinafter, an example of recognizing a face of a user is described. In detail, the object recognizer 310 may recognize the face of the user using various methods. Here, candidate sets for recognizing the face of the user may be set using various methods. The object recognizer 310 may retrieve the face of the user in response to a selection on a picture at the instant messaging service. The object recognizer 310 may classify the retrieved face of the user based on a similarity.

The object recognizer 310 may analyze context of a conversation through messages transmitted and received in a group chatroom of the instant messaging service and may recognize a face of a user from the shared image through the analyzed context. Here, the face of the user recognized by analyzing the context of the conversation transmitted and received through messages in the group chatroom of the instant messaging service may be set as a candidate set 1. The object recognizer 310 may recognize the face of the user by identifying user information registered to the instant messaging service using an image captured through an in-app camera provided at the instant messaging service. For example, a selfie (i.e., an image of a user captured based on a command provided by the user) may be captured using the in-app camera provided at the instant messaging service and the captured selfie may be transmitted to the server 150. Here, the user using the image captured through the in-app camera provided at the instant messaging service may be recognized and set as a candidate set 2. The object recognizer 310 may recognize the face of the user based on profile pictures of members present in a group chatroom of the instant messaging service. For example, the object recognizer 310 may compare the face of the user in the image with profile pictures of each of the members present in the group chatroom, and a most similar member may be identified. Here, the face of the user recognized based on the profile pictures of the members present in the group chatroom may be set as a candidate set 3. The object recognizer 310 may recognize the face of the user based on picture information within a group album present in the group chatroom of the instant messaging service. Here, pictures shared through the group chatroom may be uploaded to the group album and the face of the user recognized from the pictures uploaded to the group album may be set as a candidate set 4. For example, the object recognizer 310 may compare the face of the user in the image with the pictures uploaded to the group album, and a most similar face may be identified. For example, the group album may have data indicating which member of the group chatroom matches the most similar face, and the user may be set as the candidate set 4.

The object recognizer 310 may recognize the face of the user by clustering through comparison between candidate sets for recognizing the face of the user. The object recognizer 310 may perform compare the candidate set 1, the candidate set 2, the candidate set 3, and the candidate set 4 and may perform clustering based on a similarity. The object recognizer 310 may acquire a score by assigning a weight to each of the candidate set 1, the candidate set 2, the candidate set 3, and the candidate set 4. The object recognizer 310 may recognize the face of the user to which clustering is performed based on the acquired score. Here, candidate sets recognized from a plurality of group chatrooms may be simultaneously and alternately used by considering that a single user belongs to the plurality of group chatrooms.

The object recognizer 310 may match identification information of the user estimated through messages transmitted and received using the instant messaging service. The object recognizer 310 may additionally recognize information of the user. The object recognizer 310 may recognize identification information of the user by analyzing a style of conversation transmitted and received through messages communicated using the instant messaging service and a user account registered to the instant messaging service. For example, the object recognizer 310 may estimate user identification information, such as an age and a gender of the user, by analyzing a general conversation style of the user and a network related to a friend registered to the instant messaging service. Here, analyzing the network may refer to analyzing user information registered at a time of enrollment into the instant messaging service and data accumulated in relation to each user using the instant messaging service. For example, the object recognizer 310 may recognize user information based on a conversation of another user, for example, a friend, aside from the user.

In operation S420, the friend recommender 320 may recommend a user account of an instant messaging service retrieved in association with the recognized at least one object. For example, the friend recommender 320 may invite the retrieved user account of the instant messaging service to be a member of the group chatroom created in the instant messaging service. For example, the friend recommender 320 may provide a friend recommendation list to a friend invitation menu of the group chatroom and may provide the friend recommendation list to a member list of the group chatroom. The friend recommender 320 may invite a counterpart user (a user account) that the user desires to invite as the member of the group chatroom using the friend recommendation list of the user. Here, the friend recommender 320 may determine presence or absence of the retrieved user account of the instant messaging service in the group chatroom and may invite a user account not included in the group chatroom as the member of the group chatroom created in the instant messaging service. As another example, the friend recommender 320 may create a new group chatroom that includes the recommended user account of the instant messaging service.

Also, in response to the face of the user being identified from a picture shared in a group chatroom in which the user does not participate as a member, the friend recommender 320 may recommend members included in the group chatroom in which the picture is shared as friends of the user. For example, the friend recommender 320 may additionally provide the recommended members included in the group chatroom to the friend recommendation list of the user.

Also, the friend recommender 320 may recommend a group chatroom that includes persons present in an image, for example, a picture, selected from a group album configured in a group chatroom of the instant messaging service, such that the selected picture may be simultaneously transmitted to a plurality of group chatrooms through the instant messaging service. For example, a user interface for transmitting an image may be provided in a conversation list of the instant messaging service. In response to a selection corresponding to a picture to be transmitted through the user interface, persons included in the picture may be identified. A group chatroom to which all of the identified persons belong or group chatrooms to which the respective identified persons belong maybe recommended. In response to the user selecting a group chatroom to which the user desires to transmit the picture from among the recommended group chatrooms, the picture may be simultaneously transmitted to the plurality of chatrooms.

Also, with respect to pictures shared in the group chatroom of the instant messaging service or in a group album configured in the group chatroom, the friend recommender 320 may classify pictures of members based on each member that is included in the group chatroom and may provide the classified pictures of the members. For example, a member included in the group chatroom may be selected from the group chatroom, or a friend may be selected from a friend list registered to the instant messaging service. Alternatively, a contact profile may be selected from among members within the group chatroom. The friend recommender 320 may classify and provide pictures of the selected member, friend, or a counterpart user corresponding to the profile among pictures shared in the group chatroom or in the group album configured in the group chatroom. The user or the counterpart user may verify the pictures classified in association with the counterpart user displayed through the instant messaging service. As another example, the friend recommender 320 may classify a picture of a friend registered to the instant messaging service among pictures uploaded to the entire group chatrooms present in the instant messaging service or a group album configured in the entire group chatrooms, and may provide the classified picture of the friend. As another example, the friend recommender 320 may provide a picture of a user to display the picture of the user shared in the instant messaging service as a timeline view on a profile of the user provided at the instant messaging service. For example, the user may verify all of the pictures of the user provided in a timeline form over time through the instant messaging service, using a history view.

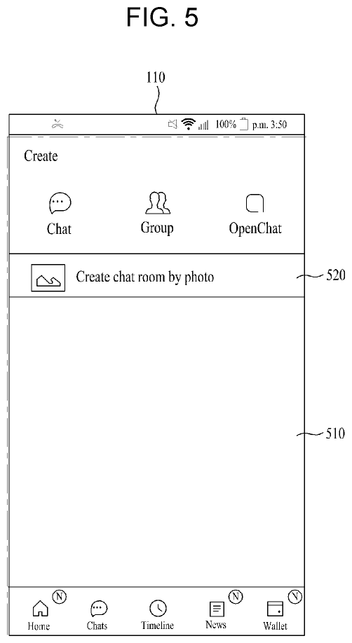

FIG. 5 illustrates an example of creating a group chatroom according to at least one example embodiment.

Referring to FIG. 5, an instant messaging service 510 may be executed on the electronic device 110. Here, a computer-implemented facial recognition system may be configured in the electronic device 110. For example, the facial recognition system may be configured in a form of an independently operating program or may be configured as an in-app form of a specific application to be operable on the specific application. Depending on example embodiments, the facial recognition system may provide the instant messaging service 510 through interaction with a server. User identification information may be registered and a user account may be created through the instant messaging service 510 when executed on the electronic device 110. For example, user identification information capable of identifying a user, such as, a telephone number, an ID, and a password of the user, may be registered to the electronic device 110. The instant messaging service 510 executed on the electronic device 110 may be provided to a friend using a counterpart electronic device, such as the electronic device 120, using the instant messaging service 510 through interaction with a telephone number stored in the electronic device 110.

A user interface 520 for creating a group chatroom using a picture may be selected at the electronic device 110. In response to a selection on the user interface 520, a group chatroom open request may be performed. In response to the selection on the user interface 520, an album for selecting a picture, for example, a photo, may be opened. Here, in response to a selection on a picture within the album, a face of the corresponding user may be recognized and the recognized counterpart user may be invited as a member of a group chatroom created in the instant messaging service 510. Alternatively, in response to the selection on the picture, a face of the corresponding user may be recognized and a new group chatroom including the recognized counterpart user may be created.

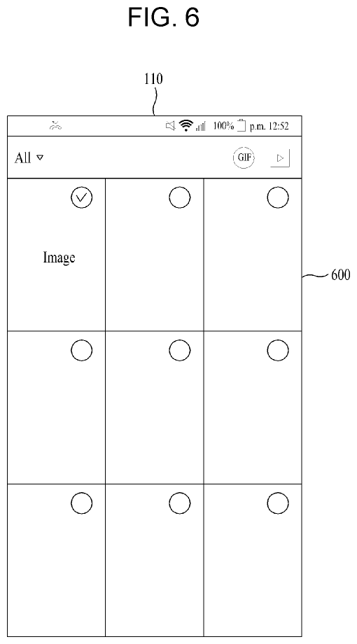

FIG. 6 illustrates an example of selecting an image according to at least one example embodiment.

Referring to FIG. 6, album information 600 stored in the electronic device 110 may be provided. Alternatively, the album information 600 being shared or stored may be provided through an instant messaging service. Also, the album information 600 stored in a group album of each group chatroom of the instant messaging service may be provided. The album information 600 may be classified based on a preset criterion and provided. For example, the album information 600 may be classified based on various criteria, such as a folder name, a period, and time order, and displayed. At least one picture, for example, a photo, may be selected from the album information 600 displayed on the electronic device 110. For example, as shown in FIG. 6 the photo in the top left corner may be selected based on an indication of the photo in the top left corner made through a user interface. Here, the aforementioned description may apply alike even to contents including an image, a video, a document file, etc., aside from a picture.

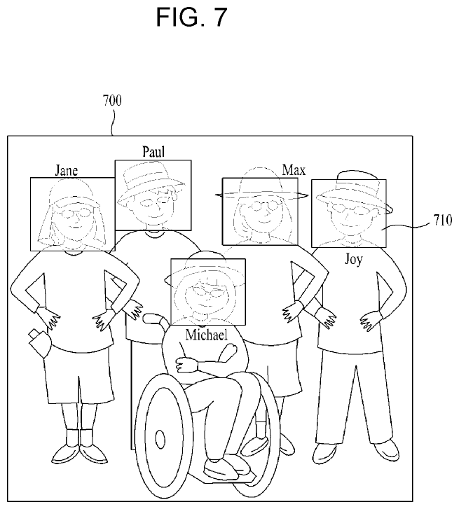

FIG. 7 illustrates an example of recognizing an object from an image according to at least one example embodiment.

Referring to FIG. 7, in response to a selection on an image 700 at an electronic device, an object 710 may be recognized from the image 700. For example, the image 700 may correspond to the photo in the top left corner in FIG. 6 selected based on the indication of the photo. Here, the electronic device may perform analysis to recognize the object 710 from the image 700. Alternatively, a server may perform analysis to recognize the object 710 from the image 700 selected at the electronic device. For example, the image 700 may be transmitted from the electronic device to the server. The server may query the electronic device for consent or dissent to collection of the image 700 selected at the electronic device. The server may or may not perform object recognition with respect to the image 700 based on the consent or the dissent received from the electronic device. In response to the consent to collection of the image 700 being received from the electronic device, the server may collect the image 700 from the electronic device and may perform the object recognition. On the contrary, in response to the dissent to the collection of the image 700 being received from the electronic device, the sever may not collect the image 700 from the electronic device, the server may not perform the object recognition and the electronic device may perform the object recognition.

For example, in a single group chatroom of an instant messaging service, the user may transmit a picture to members of the group chatroom. Here, the picture may be transmitted to the group chatroom and the context of a conversation may be analyzed through messages transmitted and received with respect to the picture in the group chatroom. Here, natural language processing of the contents of the conversation may be performed to analyze the context of the conversation. For example, a person present in the picture or another person may be described in the contents of the conversation made among the members in the group chatroom. Alternatively, in the case of selfie, a message “Didn't I photograph well?” may be transmitted and received. Through this context of the conversation, a user corresponding to a face of the user present in the picture may be estimated. In detail, using a tokenizer, paragraphs and sentences in the contents of a conversation exchanged between the user and the conversation counterpart may be classified and each paragraph or sentence may be separated into phrases and words. Morphological analysis, part-of-speech analysis, and basic-type analysis of natural language processing may be performed. Alternatively, a learning model to analyze the context of the conversation may be configured and user identification information may be acquired from the context of the conversation by training the configured learning model to learn the contents of the conversation. For example, words and phrases used to identify women or men may be extracted by analyzing the contents of the conversation and a gender may be identified based on the extracted words and phrases. Alternatively, the gender may be identified by analyzing words frequently used by women or men. Also, an age group may be estimated by classifying features, such as, for example, words frequently used by age group, frequency emoticons are used, a number of words, and a length of a sentence. Also, an age and a gender of a user may be estimated based on identification information of a friend registered to the instant messaging service.

As another example, a face of a user may be recognized by identifying user information registered to the instant messaging service using an image captured through an in-app camera provided at the instant messaging service. For example, the in-app camera may include a front camera mode configured to control a front camera of the electronic device or a rear camera mode configured to control a rear camera of the electronic device. Here, the face of the user may be recognized from a selfie of the user captured using the front camera that operates in response to execution of the front camera mode. As another example, the face of the user may be recognized based on profile pictures of members present in a group chatroom of the instant messaging service. As another example, the face of the user may be recognized based on picture information in a group album present in a group chatroom of the instant messaging service. Here, at least one user face may be recognized. Also, each candidate set may be derived based on a method of recognizing the face of the user. The face of the user may be recognized by clustering through comparison between candidate sets including the recognized face of the user.

Further, user information may be additionally recognized. For example, identification information of the user may be recognized by analyzing a conversation style of a conversation transmitted and received through messages input using the instant messaging service and a user account registered to the instant messaging service. For example, members present in a group chatroom and the face of the user included in a picture may be matched. For example, referring to FIG. 7, Jane, Paul, Michael, Max, and Joy present in the picture 700 may be recognized as the faces of the users.

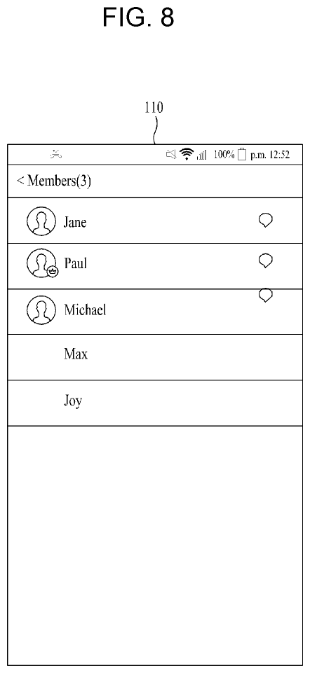

FIG. 8 illustrates an example of inviting a member to a group chatroom according to at least one example embodiment.

Members present in a group chatroom may be displayed on the electronic device 110. For example, a friend recommendation list may be provided to a member list of the group chatroom of the electronic device 110. Alternatively, the friend recommendation list may be provided to a separate friend invitation menu present in the group chatroom of the electronic device 110. The user may select a desired counterpart user from the friend recommendation list displayed on the electronic device 110 and may invite the selected counterpart user as a member of the group chatroom or may create a new group chatroom that includes the selected counterpart user. For example, in FIG. 8 Jane, Paul and Michael, recognized from the picture 700 in FIG. 7, may be in a group chatroom. Max and Joy, who are also recognized from the picture 700 in FIG. 7, may not be in the group chatroom. One of the users that is in the chatroom may select Max, Joy or Max and Joy to join the group chatroom. One of the users that is in the group chatroom may create a new chatroom that includes any one or any combination of the users recognized form the picture 700 in FIG. 7.

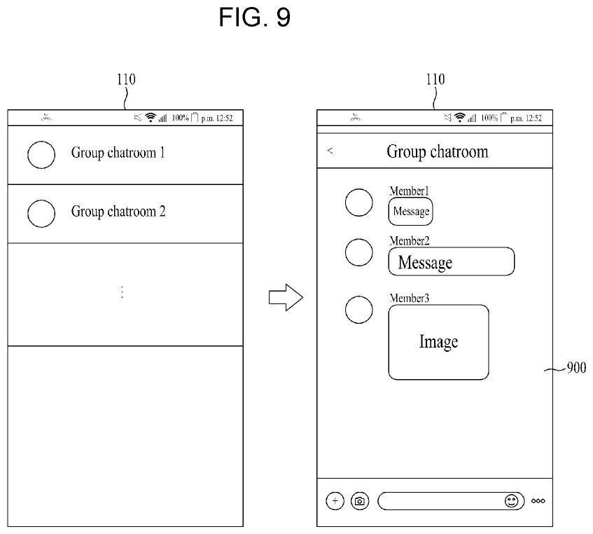

FIG. 9 illustrates an example of sharing an image according to at least one example embodiment.

A plurality of group chatrooms may be present in an instant messaging service that operates on the electronic device 110. A group chatroom list created based on group chatrooms corresponding to a user account may be provided at the instant messaging service. A user may select a group chatroom 900 in which the user desires to transmit and receive a message from the group chatroom list and may participate in the group chatroom 900. The user may transmit and receive messages with other members present in the group chatroom 900. For example, the messages may include an image. For example, a picture may be shared from one of the members present in the group chatroom 900. Here, the shared picture may be uploaded to a group album configured in the group chatroom 900 and the uploaded picture may be saved or deleted. Alternatively, the uploaded picture may be processed, for example, edited by another member, aside from a member having uploaded the picture to the group chatroom 900.

The systems or the apparatuses described herein may be implemented using hardware components, software components, and/or a combination thereof. For example, a processing device may be implemented using one or more general-purpose or special purpose computers, such as, for example, a processor, a controller and an arithmetic logic unit (ALU), a digital signal processor, a microcomputer, a field programmable array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical equipment, computer record medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable record mediums.

The methods according to the example embodiments may be recorded in non-transitory computer-readable storage media including program instructions to implement various operations embodied by a computer. The media may also include, alone or in combination with the program instructions, data files, data structures, and the like. The media and program instructions may be those specially designed and constructed for the purposes, or they may be of the kind well-known and available to those having skill in the computer software arts. Examples of non-transitory computer-readable storage media include magnetic media such as hard disks, floppy disks, and magnetic tape; optical media such as CD ROM disks and DVD; magneto-optical media such as floptical disks; and hardware devices that are specially to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be to act as one or more software modules in order to perform the operations of the above-described embodiments, or vice versa.

The foregoing embodiments are examples and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A method performed by a computer system, the method comprising:
recognizing at least one object from an image shared in an instant messaging service; and
identifying a user account of the instant messaging service associated with the recognized at least one object.

2. The method of claim 1, further comprising inviting the identified user account of the instant messaging service to be a member of a group chatroom provided by the instant messaging service.

3. The method of claim 1, further comprising creating a new group chatroom that includes the identified user account of the instant messaging service.

4. The method of claim 1, further comprising: determining whether the identified user account of the instant messaging service is a current member of a group chatroom provided by the instant messaging service; and
inviting the user account that is not the current member of the group chatroom to be a new member of the group chatroom.

5. The method of claim 1, further comprising:
identifying a face of a user that is a member of a chatroom from a picture shared in another group chatroom in which the user does not participate as a member; and
providing a friend recommendation interface to the user indicating members included in the other group chatroom in which the picture is shared.

6. The method of claim 1, further comprising:
receiving an indication of a picture selected from a group album;
identifying at least one group chatroom of the instant messaging service that includes members corresponding to persons present in the picture; and
transmitting the selected picture to the at least one group chatroom.

7. The method of claim 1, further comprising:
classifying, with respect to pictures shared in a group chatroom of the instant messaging service or in a group album configured in the group chatroom, pictures of members included in the group chatroom; and
providing the classified pictures of the members.

8. The method of claim 1, further comprising:
classifying a picture of a friend registered to the instant messaging service among pictures uploaded to all group chatrooms present in the instant messaging service or a group album configured in one of the group chatrooms; and
providing the classified picture of the friend.

9. The method of claim 1, further comprising providing a timeline view on a profile of a user provided at the instant messaging service that includes pictures of the user shared in the instant messaging service.

10. The method of claim 1, wherein the recognizing comprises analyzing context of a conversation through messages transmitted and received in a group chatroom of the instant messaging service and recognizing a face of a user from the shared image based on the analyzed context, and
wherein the user is recognized as the at least one object.

11. The method of claim 1, further comprising registering user information to the instant messaging service based on an image captured through an in-app camera provided at the instant messaging service,
wherein the recognizing comprises recognizing a face of a user from the shared image based on the user information registered to the instant messaging service using the image captured through the in-app camera.

12. The method of claim 1, wherein the recognizing comprises recognizing a face of a user from the shared image based on profile pictures of members present in a group chatroom of the instant messaging service.

13. The method of claim 1, wherein the recognizing comprises recognizing a face of a user from the shared image based on picture information within a group album present in a group chatroom of the instant messaging service.

14. The method of claim 1, wherein the recognizing comprises analyzing context of a conversation through messages transmitted and received in a group chatroom of the instant messaging service and recognizing a face of a user from the shared image by clustering through comparison between candidate sets for recognizing the face of the user, and
wherein the user is recognized as the at least one object.

15. The method of claim 1, wherein the recognizing comprises generating identification information of a user estimated based on messages transmitted and received using the instant messaging service, and
wherein the at least one object is recognized from the shared image based on the generated identification information.

16. The method of claim 15, further comprising generating the identification information of the user by analyzing a conversation style of a conversation transmitted and received through messages input using the instant messaging service and a user account registered to the instant messaging service.

17. A non-transitory computer-readable record medium storing instructions that, when executed by a processor, cause the processor to perform a method that includes:
recognizing at least one object from an image shared in an instant messaging service; and
identifying a user account of the instant messaging service associated with the recognized at least one object.

18. A computer system for performing a user face recognition, the computer system comprising:
at least one memory configured to store computer-readable instructions; and
at least one processor configured to execute the computer-readable instructions to implement:
an object recognizer configured to recognize at least one object from an image shared in an instant messaging service; and
a friend recommender configured to identify a user account of the instant messaging service associated with the recognized at least one object.

19. The computer system of claim 18, wherein the friend recommender is further configured to invite the identified user account of the instant messaging service to be a member of a group chatroom provided by the instant messaging service, or to create a new group chatroom that includes the identified user account of the instant messaging service.

20. The computer system of claim 18, wherein the object recognizer is further configured to analyze context of messages transmitted and received in a group chatroom of the instant messaging service and to recognize a face of a user from the shared image through the analyzed context as the at least one object.
